(19) United States
(12) Patent Application Publication
(10) Pub. No.: US 2023/0269339 A1
(43) Pub. Date: Aug. 24, 2023

(54) COMMUNICATION APPARATUS AND METHOD OF CONTROLLING SAME

(71) Applicant: CANON KABUSHIKI KAISHA, Tokyo (JP)

(72) Inventor: TAKAFUMI ISHII, Kanagawa (JP)

(21) Appl. No.: 18/110,402

(22) Filed: Feb. 16, 2023

(30) Foreign Application Priority Data
Feb. 22, 2022 (JP) 2022-025604

(51) Int. Cl. H04N 1/327; H04W 76/19; H04N 1/44; H04N 1/00; H04W 12/06

(52) U.S. Cl. CPC H04N 1/32765; H04W 76/19; H04N 1/32786; H04N 1/4426; H04N 1/00244; H04N 1/4413; H04N 1/4433; H04W 12/06; H04N 2201/0094; H04N 1/32789; H04N 2201/0048

(57) ABSTRACT

A communication apparatus is provided. The communication apparatus receives first information relating to IEEE 802.1X authentication from an information processing apparatus via a first wireless connection between the communication apparatus and another apparatus, terminates the first wireless connection, executes the IEEE 802.1X authentication based on the first information received in a state in which the first wireless connection is not established, and executes processing to re-establish the first wireless connection on the basis of the IEEE 802.1X authentication failing.

### BACKGROUND OF THE INVENTION

### Field of the Invention

The present invention relates to a communication apparatus and a method of controlling the same.

### Description of the Related Art

With a wireless LAN compliant with the IEEE 802.11 standards, radio waves are used as a communication medium, making security issues important. To solve this problem, a wireless communication method has been used which uses a wireless LAN based on the IEEE 802.11 standards and protects the network by authenticating communication apparatuses that connect to the network. Wireless LAN authentication methods include the Pre-Shared Key (PSK) method using PSK and the Simultaneous Authentication of Equals (SAE) method using SAE. Another wireless LAN authentication method includes the Extensible Authentication Protocol (EAP) method for authenticating communication apparatuses that connect to the network using an authentication server compatible with IEEE 802.1X/EAP.

In Japanese Patent Laid-Open No. 2004-302846, a method of controlling an information processing apparatus for connecting a user unable to connect to an authentication server compatible with IEEE 802.1X/EAP to a network using the same access point is described.

With apparatuses that can execute processing to connect to a wireless LAN using IEEE 802.1X/EAP becoming more common, there is a demand for an enhancement to the user-friendliness of communication apparatuses that execute processing to connect to a wireless LAN using the IEEE 802.1X/EAP authentication method.

### SUMMARY OF THE INVENTION

The present invention can enhance the user-friendliness of a communication apparatus that executes processing to connect to a wireless LAN using the IEEE 802.1X/EAP authentication method.

The present invention has the following configuration. In other words, according to an aspect of the invention, a communication apparatus comprising: at least one processor; and at least one memory including at least one program, wherein the at least one program causes the at least one processor to receive first information relating to IEEE 802.1X authentication from an information processing apparatus via a first wireless connection between the communication apparatus and another apparatus, terminate the first wireless connection, execute the IEEE 802.1X authentication based on the first information received in a state in which the first wireless connection is not established, and execute processing to re-establish the first wireless connection on the basis of the IEEE 802.1X authentication failing is provided.

According to another aspect of the invention, a method of controlling a communication apparatus comprising: receiving first information relating to IEEE 802.1X authentication from an information processing apparatus via a first wireless connection between the communication apparatus and another apparatus; terminating the first wireless connection; executing the IEEE 802.1X authentication based on the first information received in a state in which the first wireless connection is not established; and executing processing to re-establish the first wireless connection on the basis of the IEEE 802.1X authentication failing is provided.

According to the present invention, the user-friendliness of a communication apparatus that executes processing to connect to a wireless LAN using the IEEE 802.1X/EAP authentication method can be enhanced.

Further features of the present invention will become apparent from the following description of exemplary embodiments with reference to the attached drawings.

### BRIEF DESCRIPTION OF THE DRAWINGS

FIG. 1 is a diagram illustrating an example of a system configuration.

FIG. 2 is a diagram illustrating an example of the appearance configuration of an MFP.

FIG. 3 is a diagram illustrating an example of the configuration of the MFP.

FIGS. 4A, 4B, and 4C are diagrams illustrating examples of screens displayed on an operation display unit of the MFP.

FIG. 5 is a diagram illustrating an example of the appearance configuration of an information processing apparatus.

FIG. 6 is a diagram illustrating an example of the configuration of the information processing apparatus.

FIG. 7 is a diagram illustrating an example of the configuration of an access point.

FIG. 8 is a diagram illustrating an example of the configuration of an authentication server.

FIG. 9 is a diagram illustrating an overview of the process executed when a connection between the MFP and a network operating via an authentication method using an authentication server fails.

FIGS. 10A to 10C are diagrams illustrating examples of network configurations.

FIGS. 11A to 11J are diagrams illustrating examples of screens displayed when setting LAN settings on the operation display unit of the MFP.

FIGS. 12A to 12G are diagrams illustrating examples of MFP settings screens displayed on the information processing apparatus.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

System Configuration

FIG. 1 illustrates an example configuration of a communication system according to the present embodiment. For example, in the present system, a plurality of communication apparatuses are configured to wirelessly communicate with one another. In the present embodiment, the communication apparatuses are devices that communicate with one another but are not limited to devices (for example, an access point, switch, or the like) for providing a communication environment. Herein, an information processing apparatus 200, a multifunction printer (MFP) 300, an access point 700, and an authentication server 800 as used as the plurality of communication apparatuses.

Note that the information processing apparatus 200 and the MFP 300 may be referred to simply as communication apparatuses when no distinction is necessary. For example, the MFP 300 may be referred to as the communication apparatus 300 as in FIG. 1.

The information processing apparatus 200 is an information processing apparatus with a communication function based on a wireless LAN, a wired LAN, or the like. Wireless LAN may be referred to as WLAN. Examples of the information processing apparatus 200 include a smartphone, a notebook personal computer (notebook PC (a multifunction peripheral), a tablet terminal, a Personal Digital Assistant (PDA), and the like.

The MFP 300 is a printing device including a printing function as a main function. The MFP 300 may also include subsidiary functions including a reading function (scanning function), a facsimile (FAX) function, a telephone function, and the like. Also, the MFP 300 has a communication function enabling wireless communication with the information processing apparatus 200. The present embodiment is described using the MFP 300 as an example. However, no such limitation is intended. For example, instead of the MFP 300, a facsimile machine, a scanner, a projector, a portable terminal, a smartphone, a notebook PC, a tablet terminal, a PDA, or the like may be used. Alternatively, a digital camera, a music playback device, a television, a smart speaker, Augmented Reality (AR) glasses, or the like may be used. The MFP 300, for example, receives print data including image data from an information processing apparatus that is connected via the access point 700 and forms an image on the basis of the data. Alternatively, the MFP 300, for example, transmits image data read by the scanner function to an information processing apparatus that is connected via the access point 700. Other control information and the like can also be exchanged with a network that is connected via the access point 700.

The access point (AP) 700 is provided separately (external to) the information processing apparatus 200 and the MFP 300 and operates as a WLAN base station apparatus or a wireless base station. A communication apparatus with a WLAN communication function can communicate in the WLAN infrastructure mode via the access point 700. The access point 700 wirelessly communicates with a communication apparatus that has been allowed to connect to the access point 700 (in other words, an authenticated communication apparatus) and relays wireless communication between the communication apparatus and another communication apparatus. Also, the access point 700 is, for example, connected to a wired communication network and can relay communication between a communication apparatus connected to the wired communication network and another communication apparatus wirelessly connected to the access point 700.

When authentication method of a network formed by the access point 700 is a method using the authentication server 800, the access point 700 cooperates with the authentication server 800 and performs access control by performing authentication of communication apparatuses that connect to the network. The communication apparatus that connects to the network formed by the access point 700 may have restricted communication with apparatuses other than the authentication server 800 until authenticated. Note that the access point 700 may be support an authentication method that does not use an authentication server. An authentication method using an authentication server and an authentication method not using an authentication server will be described below in detail.

The authentication server (Radius server) 800 is provided separately to the information processing apparatus 200, the MFP 300, and the access point 700 and collectively manages the authentication information. The authentication server 800, for example, can execute authentication processing compliant with the IEEE 802.1X standards. In the present embodiment, the authentication server 800 cooperates with the access point 700, performs authentication of a terminal corresponding to the authentication target, and performs access control of the terminal on the basis of the authentication result.

Herein, the access point 700 corresponds to an authenticator according to IEEE 802.1X. Also, the information processing apparatus 200 and the MFP 300 correspond to a supplicant according to IEEE 802.1X.

The authentication server 800 performs authentication according to the IEEE 802.1X standards using the Extensible Authentication Protocol Transport Layer Security (EAP-TLS) method or the EAP-Tunneled TLS (EAP-TTLS) method, for example. The EAP-TLS method is an authentication method using a TLS Handshake Protocol and enables authentication to be performed using a server certificate, a client certificate, and the like. The EAP-TTLS method is an authentication method using a TLS Handshake Protocol and enables authentication to be performed using a server certificate, a username, a password, and the like. In another example, the authentication server 800 can perform authentication according to the IEEE 802.1X standards using the Protected EAP (PEAP) method. With the PEAP method, authentication can be performed using a username and a password. This information used in authentication according to IEEE 802.1X may be referred to as authentication information.

The information processing apparatus 200 and the MFP 300 can perform, using the respective WLAN communication functions, wireless communication in wireless infrastructure mode via the external access point 700 or in peer-to-peer (P2P) mode bypassing the external access point 700. P2P mode includes Wi-Fi Direct (registered trademark) (WFD), SoftAP mode, and the like. In other words, the communication described above may be implemented via wireless direct compliant with the IEEE 802.11 series. Note that the information processing apparatus 200 and the MFP 300 can execute processing compatible with a plurality of printing services using WLAN communication. The details of this will be described below.

MFP Appearance Configuration

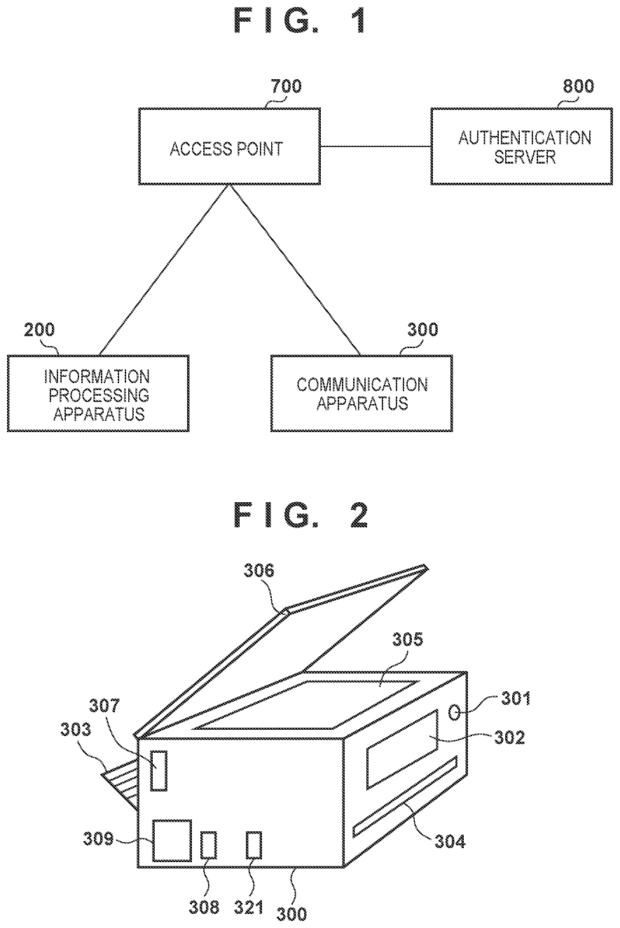

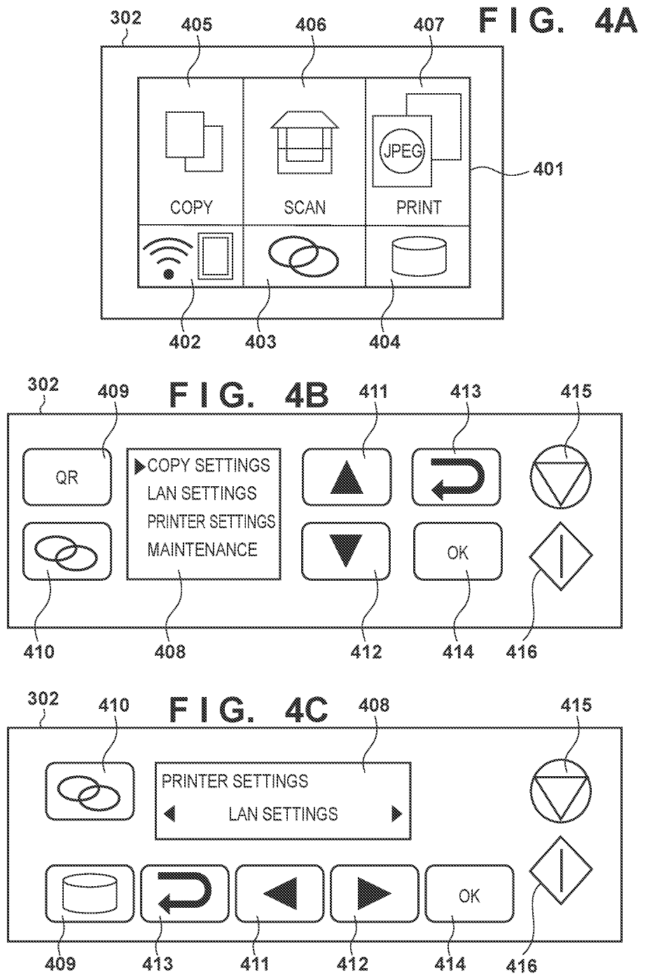

FIG. 2 is a perspective view illustrating an example of the appearance configuration of the MFP 300. The MFP 300 includes an operation display unit (control panel) 302, a printing paper insertion opening 303, a printing paper discharge opening 304, a platen 305, and a document cover 306. On the housing of the MFP 300, a physical key used when turning on and off the power supply 309 is provided as a power button 301. The operation display unit 302 includes displays and buttons used when operating the MFP 300. For example, the operation display unit 302 includes a plurality of keys including a character input key, a cursor key, an enter key, a cancel key, and the like and a light source including a Light Emitting Diode (LED), a Liquid Crystal Display (LCD), and the like. The operation display unit 302 is configured to receive the operation input of a user when activating the functions of the MFP 300, when changing the various settings, and the like. Typically, a touch panel display is used as the operation display unit 302 (see FIGS. 4A to 4C).

The printing paper insertion opening 303 is an insertion opening in which sheets of a discretionary size can be set. The sheets set in the printing paper insertion opening 303 are conveyed one by one to a printing unit, and the post-printing sheets are discharged from the printing paper discharge opening 304. The platen 305 is a transparent, glass platform used when reading an image using the scanning function of a document placed on the platen 305. The document cover 306 is a cover for pressing the document against the platen 305 so that the document does not lift up from the platen 305 when reading an image using the scanning function. The document cover 306 can also shield the inside of the MFP 300 body from external light.

Also, the MFP 300 has a communication function using WLAN and/or wired LAN. In the present embodiment, the MFP 300 is provided with a built-in antenna for implementing wireless communication as well as a wired LAN communication unit 321. Also, the MFP 300 is provided with a USB communication unit 308 that can implement communication with the external information processing apparatus 200 and the like via a USB connection.

MFP Configuration

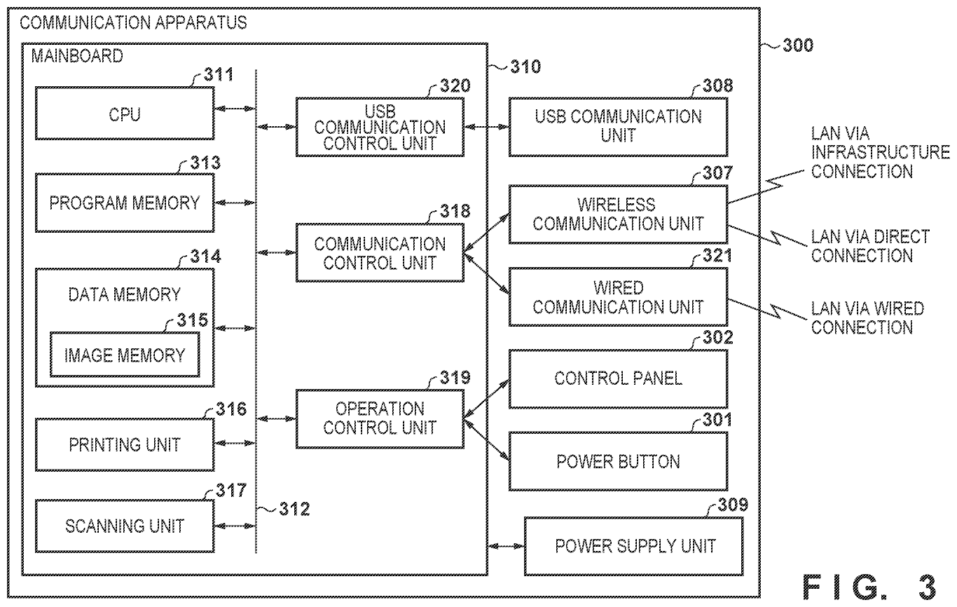

FIG. 3 is a block diagram illustrating an example of the configuration of the MFP 300. The MFP 300 further includes a built-in mainboard 310 for controlling the entire apparatus as well as a wireless communication unit 307 and a USB communication unit 308. The mainboard 310 includes a central processing unit (CPU) 311, an internal bus 312, a program memory 313, a data memory 314, a printing unit 316, a scanning unit 317, a communication control unit 318, an operation control unit 319, and a USB communication control unit 320. Note that hereinafter, the processing described as processing executed by the MFP 300 is actually implemented by the CPU 311 executing a program stored on the program memory 313, the data memory 314, or the like.

The CPU 311, the program memory 313, and the data memory 314 correspond to a microprocessor, a Read Only Memory (ROM), and a Random Access Memory (RAM), respectively. In the present embodiment, the CPU 311, the program memory 313, and the data memory 314 are connected to one another via a bus cable forming the internal bus 312. The CPU 311 executes calculation processing for implementing the various functions described in the embodiment on the basis of a control program stored in the program memory 313 and the contents of the data memory 314.

For example, the CPU 311 can control the scanning unit 317, read a document, and store the image (image data) in image memory 315 in the data memory 314. The CPU 311 can control the printing unit 316 and print the image stored in the image memory 315 on a printing medium. The CPU 311 can control the USB communication unit 308 via the USB communication control unit 320 and perform USB communication with the external information processing apparatus 200 via a USB connection. The CPU 311 can control the operation control unit 319 and receive information indicating an operation input from the power button 301 or the operation display unit 302. Also, the CPU 311 can control the operation control unit 319 and display the status of the MFP 300 or a function select menu on the operation display unit 302.

The wireless communication unit 307 is configured to provide a WLAN communication function and provides a similar function to that of a WLAN unit 201 of the information processing apparatus 200, for example. In other words, the wireless communication unit 307 transmits a packet converted from data by a mode compliant with a predetermined standard or restores a packet from another device to its original data and outputs this to the CPU 311. The wireless communication unit 307 is configured to execute data (packet) communication in a WLAN system compliant with the IEEE 802.11 standard series (IEEE 802.11a/b/g/n/ac/ax and the like) and may also be compliant with other standards. In this example, the wireless communication unit 307 can communicate on a 2.4 GHz frequency band channel or a 5 GHz frequency band channel. The wireless communication unit 307 can further execute communication based on WFD, communication using a software enabled access point (SoftAP) mode, communication using a wireless infrastructure mode, and the like. The details thereof are described below. Also, the information processing apparatus 200 and the MFP 300 can perform wireless direct communication based on WFD, and the wireless communication unit 307 may include a software enabled AP function or a group owner function. In other words, the wireless communication unit 307 can form a network for P2P communication and determine the channel used for P2P communication.

The wired LAN communication unit 321 is configured to implement wired communication. For example, the wired LAN communication unit 321 can implement data (packet) communication in a wired LAN (Ethernet) system compliant with the IEEE 802.3 series. Also, with wired communication using the wired LAN communication unit 321, communication in a wired mode is possible. In this example, the wired LAN communication unit 321 is connected to the mainboard 310 via a bus cable forming the internal bus 312.

MFP Operation Display Unit

FIGS. 4A to 4C are diagrams schematically illustrating examples of the configuration of the operation display unit 302 of the MFP 300. FIG. 4A is an example when a touch panel display 401 is used as the operation display unit 302.

The user can activate the MFP 300 by touching the power button 301. When the MFP 300 is activated, a home screen (typically, the highest in the menu hierarchy) is displayed on the touch panel display 401 as a screen where the user can input an operation.

The home screen includes a copy region 405, a scan region 406, and a print region 407. The copy region 405 accepts instructions to execute copying processing. The scan region 406 accepts instructions to execute scanning processing. The print region 407 accepts instructions to execute printing processing.

Also, the home screen may further include a status display region 402, a connection settings mode region 403, and a settings region 404. The status display region 402 indicates the settings and connection status of the infrastructure mode wireless connection, the wireless direct connection, or the like of the MFP 300. The user can start the connection settings mode at a discretionary timing via the connection settings mode region 403. Also, the user can change various settings using the settings region 404. Settings which can be changed include LAN settings, for example.

FIG. 4B is a diagram of an example when a relatively small LCD display 408 and various physical keys 409 to 416 are used as the operation display unit 302.

When the MFP 300 is activated, a home screen is displayed on the LCD display 408. The cursor displayed on the LCD display 408 can be operated by the user pressing the move cursor buttons 411 and 412. An operation is executed when the user presses the OK button (enter button) 414, and the most previous menu screen is returned to when the user presses the return button 413. The user can set the LAN settings by selecting the LAN settings by selecting and deciding in this manner. Also, a QR code (registered trademark) including information required for direct connection to the MFP 300 can be displayed when the QR button 409 is pressed. Note that the displayed code is not limited to a QR code (registered trademark) and may be any code able to be optically read. A direct connection and wireless communication between the information processing apparatus 200 and the MFP 300 is enabled when the QR code (registered trademark) is read from the information processing apparatus 200. Also, by pressing a connection settings mode button 410, the connection settings mode can be started, and by transmitting the connection information to the MFP 300 using the information processing apparatus 200, the MFP 300 can be connected to the access point 700. Various processing can be canceled, by a stop button 415 being pressed while the MFP 300 is executing processing. The MFP 300 can scan a document and execute printing by the user pressing a copy start button 416.

As illustrated in FIG. 4C, the layout of FIG. 4B may be changed as appropriate. For example, the cursor operation may be performed in the left-and-right direction. Note that the components 408 to 416 described above may be simply referred to as a screen. For example, the LCD display 408 may be referred to as the screen 408. The user can set the settings for the LAN (LAN settings) from the operation display unit 302 configured as illustrated in FIG. 4C, for example.

Information Processing Apparatus Appearance Configuration

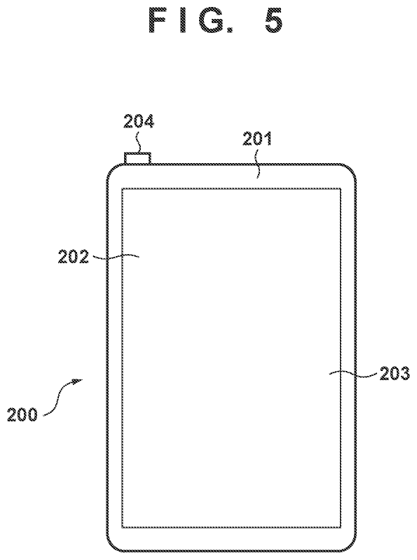

FIG. 5 is a diagram illustrating an example of the appearance configuration of the information processing apparatus 200. In the present embodiment, the information processing apparatus 200 is a smartphone and includes a display unit 202, an operation unit 203, and a power key 204. The power key 204 is provided as a physical key for turning on and off the power supply of the information processing apparatus 200. In the present embodiment, the display unit 202 is a display including an LCD display mechanism, but in other embodiments, LED or the like may be used to display information. Also, the information processing apparatus 200 may include a function for outputting information via audio that comes together with the display unit 202 or that can be replaced. The operation unit 203 includes physical keys such as keys, buttons and/or a touch panel and is configured to detect the operation input of the user.

In the present embodiment, the function of the display unit 202 and the function of the operation unit 203 use a touch panel display. In other words, the display unit 202 and the operation unit 203 are implemented as a single apparatus. In this case, button icons and an on-screen keyboard are displayed using the function of the display unit 202, and user operation input of these is detected by the function of the operation unit 203. In other embodiments, the display unit 202 and the operation unit 203 may be provided as separate pieces of hardware.

Also, the WLAN unit 201 configured to provide a WLAN communication function may be a built-in component of the information processing apparatus 200. The WLAN unit 201 is configured to execute data (packet) communication in a WLAN system compliant with the IEEE 802.11 standard series (IEEE 802.11a/b/g/n/ac/ax and the like), for example. The WLAN unit 201 may be configured to execute WLAN communication compliant with another standard. In this example, the WLAN unit 201 can communicate on both a 2.4 GHz frequency band channel and a 5 GHz frequency band channel. Also, the WLAN unit 201 can execute communication based on WFD, communication using a SoftAP mode, communication using a wireless infrastructure mode, and the like. The details thereof are described below.

Information Processing Apparatus Configuration

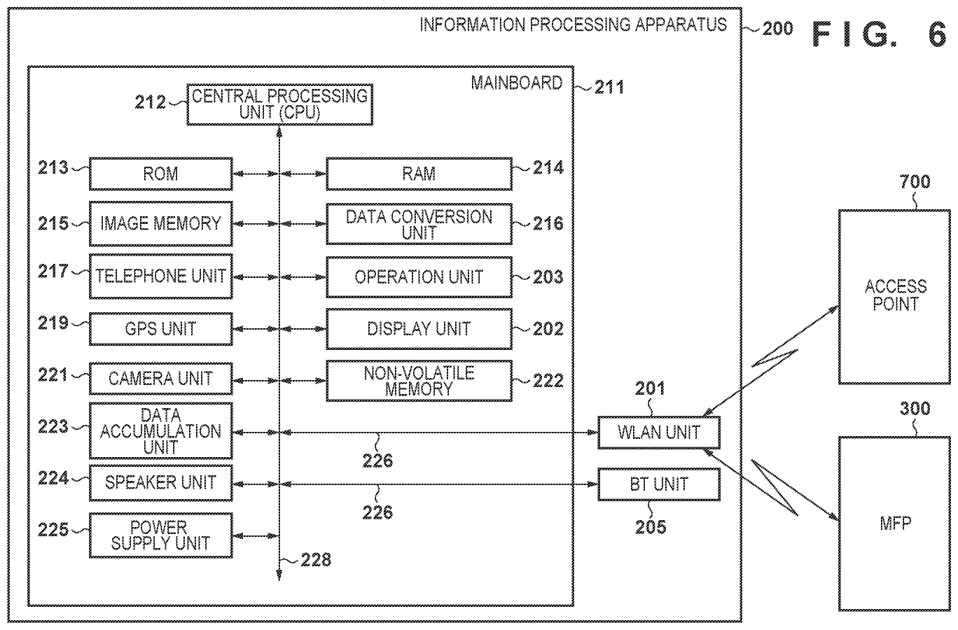

FIG. 6 is a diagram illustrating an example of the configuration of the information processing apparatus 200. The information processing apparatus 200 includes a mainboard 211 for executing main control of the apparatus itself, the WLAN unit 201 for performing WLAN communication, and a Bluetooth (registered trademark) (BT) unit 205.

In the present embodiment, the mainboard 211 includes a CPU 212, a ROM 213, a RAM 214, an image memory 215, and a data conversion unit 216. The mainboard 211 further includes a telephone unit 217, a Global Positioning System (GPS) 219, a camera unit 221, a non-volatile memory 222, a data accumulation unit 223, a speaker unit 224, and a power supply unit 225. The functional units inside the mainboard 211 are connected to one another via a system bus 228 and are managed by the CPU 212. Also, a dedicated bus 226 connects the mainboard 211 and the WLAN unit 201 and the mainboard 211 and the BT unit 205.

The CPU 212 functions as a system control unit for controlling the components of the information processing apparatus 200. In this example, the examples of functions of the information processing apparatus 200 and the processing described as processing executed by the information processing apparatus 200 are implemented by the CPU 212 loading a program stored in the ROM 213 on the RAM 214 and executing the program.

More specifically, the ROM 213 stores a control program executed by the CPU 212, an embedded operating system (OS) program, and the like. By the CPU 212 executing compatible programs using the embedded OS, software control such as scheduling, task switch, and the like is performed. The RAM 214 is constituted by a Static RAM (SRAM) or the like. The RAM 214 stores variables for program control, setting values registered by the user, management data for managing the information processing apparatus 200, and various types of data. The RAM 214 may be used as a buffer for various types of work. The image memory 215 is constituted by a memory such as a Dynamic RAM (DRAM). The image memory 215 temporarily stores image data received via the WLAN unit 201 and image data read out from the data accumulation unit 223 and makes them able to be processed by the CPU 212. The non-volatile memory 222 is constituted by a memory such as a flash memory, for example, and retains stored data even when the power of the information processing apparatus 200 is turned off.

Note that the memory configuration of the information processing apparatus 200 is not limited to the example described above. For example, the image memory 215 and the RAM 214 may be provided in common, and data backup may be performed using the data accumulation unit 223. Also, in this example, DRAM was given as an example of the image memory 215. However, another storage medium such as a hard disk drive (HDD) or a non-volatile memory may be used.

The data conversion unit 216 performs data conversion including color conversion, image conversion, and the like as well as performing analysis of data of various formats. The telephone unit 217 performs control of a telephone line and can implement telephone communication by processing audio data input/output via the speaker unit 224. The GPS unit 219 receives radio waves sent from satellites and obtains position information, for example the current latitude and longitude of the information processing apparatus 200. The camera unit 221 includes a function of electronically recording and encoding an image input via a lens. The image data obtained via image capture by the camera unit 221 is stored in the data accumulation unit 223. The speaker unit 224 performs control to implement functions including audio input/output for the telephone function, alarm notifications, and the like. The power supply unit 225 includes a battery and controls the supply of power to the components inside the apparatus. Power states include a dead battery state in which the battery remaining amount is equal to or less than a reference, a power off state in which the power key 204 has not been pressed, a power on state (activated state) in which the power key 204 has been pressed, a power saving state in which the amount of power consumed by the components is restricted.

The display unit 202 electronically controls the display content and performs control for displaying an operation input by the user, the operation status of the MFP 300, the status situation, and the like. The operation unit 203, in response to receiving an operation input from the user, outputs an electrical signal corresponding to this operation input to the CPU 212. A touch panel display may be used as the display unit 202 and the operation unit 203 as described using FIG. 5.

The information processing apparatus 200 can perform wireless communication using the WLAN unit 201 and communicate data with another device such as the MFP 300. For example, the information processing apparatus 200 converts data to a packet and transmits this to an external device. Also, the information processing apparatus 200 receives a packet from an external device via the WLAN unit 201, restores the packet to the original data, and outputs this to the CPU 212.

The configuration of the mainboard 211 is not limited to the example described above. For example, the functions of the mainboard 211 implemented by the CPU 212 may be implemented via a processing circuit such as an application specific integrated circuit (ASIC) or in other words may be implemented by hardware or software.

Access Point Configuration

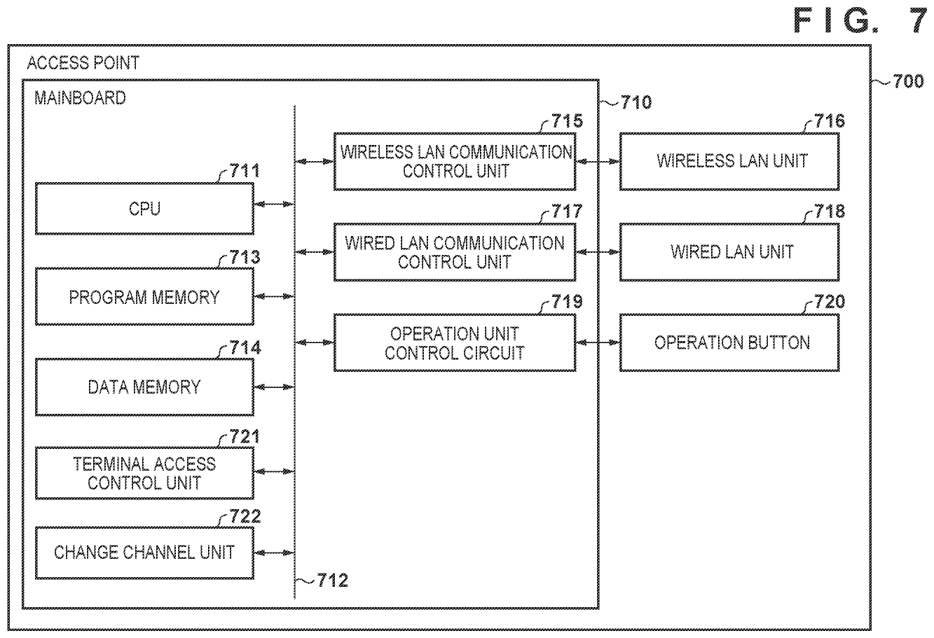

FIG. 7 is a diagram illustrating an example of the configuration of the access point 700 including a wireless LAN access point function. The access point 700 includes a mainboard 710 for performing system control, a wireless LAN unit 716, a wired LAN unit 718, and an operation button 720. The mainboard 710 includes a CPU 711, a program memory 713, a data memory 714, a wireless LAN communication control unit 715, a wired LAN communication control unit 717, an operation unit control circuit 719, a terminal access control unit 721, and a change channel unit 722. These are communicatively connected to one another via an internal bus 712. Note that hereinafter, the processing described as processing executed by the access point 700 is actually implemented by the CPU 711 executing a program stored on the program memory 713, the data memory 714, or the like.

The CPU 711 performs calculation processing on the basis of a control program stored in the program memory 713 and data stored in the data memory 714. The CPU 711 can control the wireless LAN unit 716 via the wireless LAN communication control unit 715 and perform wireless LAN communication with another information processing apparatus. The CPU 711 can control the wired LAN unit 718 via the wired LAN communication control unit 717 and perform wired LAN communication with another information processing apparatus. Also, the CPU 711 can accept an operation input from the user via the operation button 720 by controlling the operation unit control circuit 719.

The terminal access control unit 721 protects the network by authenticating communication apparatuses that connect to the network. Examples of the authentication method include the Pre-Shared Key (PSK) method using PSK and the Simultaneous Authentication of Equals (SAE) method using SAE. Also, the IEEE 802.1X authentication method using an authentication server operating as an EAP is an example of an authentication method (authentication protocol) used when executing authentication according to the WPA3-Enterprise standards. Since an EAP is used in the IEEE 802.1X authentication method, the IEEE 802.1X authentication method may be referred to as the IEEE 802.1X/EAP authentication method. An EAP method using an authentication server compatible with IEEE 802.1X/EAP may be used (hereinafter, IEEE 802.1X/EAP may be simply referred to as 802.1X/EAP). Also, the IEEE 802.1X/EAP authentication method may be referred to as the EAP method. A channel with communication authenticated in this manner can be changed or switched by the change channel unit 722. Note that in the present embodiment, the authentication method not using an authentication server is the PSK method or the SAE method, and the authentication method using an authentication server is the EAP method. Also, the authentication method not using an authentication server may be referred to as the Personal method, and the authentication method using the authentication server may be referred to as the Enterprise method.

Authentication Server Configuration

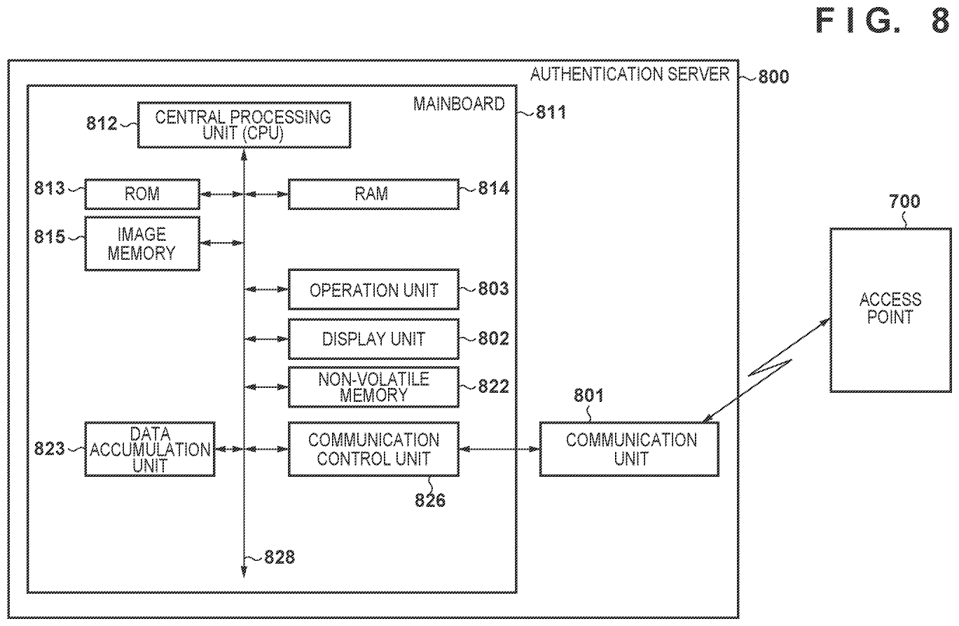

FIG. 8 is a diagram illustrating an example of the configuration of the authentication server 800. The authentication server 800 includes a mainboard 811 for performing system control and a communication unit 801 for performing wired LAN communication.

The mainboard 811 includes a CPU 812, a ROM 813, a RAM 814, an image memory 815, a non-volatile memory 822, a data accumulation unit 823, and a communication control unit 826. The mainboard 811 further includes a display unit 802 and an operation unit 803. These are connected to one another via a system bus (bus cable) 828. Also, the mainboard 811 is connected to the communication unit 801 via the communication control unit 826.

The CPU 812 functions as a system control unit for controlling the entire authentication server 800. The processing of the authentication server 800 is implemented by the CPU 812 loading a program stored in the ROM 813 on the RAM 814 and executing the program.

More specifically, the ROM 813 stores a control program executed by the CPU 812, an embedded OS program, and the like. By the CPU 812 executing compatible programs using the embedded OS, software control such as scheduling, task switch, and the like is performed. The RAM 814 is constituted by an SRAM or the like. The RAM 814 stores variables for program control, setting values registered by the user, management data for managing the authentication server 800, and various types of data. The RAM 814 may be used as a buffer for various types of work. The image memory 815 is constituted by a memory such as a DRAM. The image memory 815 temporarily stores image data received via the communication unit 801 and image data read out from the data accumulation unit 823 and makes them able to be processed by the CPU 812. The data accumulation unit 823 is constituted by a storage medium such as a Solid State Drive (SSD), for example, and retains stored data even when the power of the authentication server 800 is turned off. As the data accumulation unit 823, other storage media such as a HDD, a non-volatile memory, and the like may be used, for example.

Note that the functions of the mainboard 811 described herein may be implemented by hardware or software in a similar manner to the mainboard 211.

The display unit 802 electronically controls the display content and performs control for displaying an operation input by the user, the status situation, and the like. The operation unit 803, in response to receiving an operation input from the user, outputs an electrical signal corresponding to this operation input to the CPU 812.

The authentication server 800 can perform data communication with the access point 700 (or another device) via the communication unit 801 by using the communication control unit 826 and, for example, converts the data into a packet and transmits this to an external device. Also, the communication unit 801 receives a packet from an external device, restores the packet to the original data, and outputs this to the CPU 812. The communication unit 801, for example, is capable of data (packet) communication in a wired LAN (Ethernet) system compliant with the IEEE 802.3 series.

P2P Mode

Wireless direct communication will be described in which communication apparatuses using WLAN communication communicate and connect to one another wirelessly and directly (directly bypassing the external access point 700). For example, the communication apparatuses support a plurality of modes for wireless direct communication and can execute P2P communication (WLAN) selectively using any one of the plurality of modes. For P2P modes, two modes are expected. They are:
Mode A (software enabled AP mode), and
Mode B (Wi-Fi Direct (WFD) mode.

The communication apparatus that can execute P2P communication may be configured to support at least one of the plurality of modes. Note that in the present embodiment, mode A and mode B are collectively referred to as wireless direct. The communication apparatus that can execute P2P communication does not need to support all of the modes and may be configured to support only some modes. Note that the MFP 300 operating in P2P mode operates as a master in the connection and communication with another apparatus. In other words, in the softAP mode, the MFP 300 operates as the software enabled access point (AP). Also, in the WFD mode, the MFP 300 operates as the group owner. Note that the WFD mode is not limited thereto, and by executing group owner negotiation, the MFP 300 may operate as a station. Also, beside P2P mode, the communication apparatus may also support a wireless infrastructure mode (mode C).

With the communication apparatus (for example, the information processing apparatus 200) including a communication function using WFD, when a user operation is received via the operation unit, an application for implementing the communication function (or a dedicated application) is invoked. The communication apparatus may display a user interface (UI) screen provided by the application, prompt the user for an operation input, and execute WFD communication on the basis of the input operation.

Note that the state of the MFP 300 operating in P2P mode is illustrated in FIG. 10C. In this state, communication may be implemented between the MFP 300 and the information processing apparatus 200 bypassing the authentication server 800 and the access point 700.

Wireless Infrastructure Mode

In the wireless infrastructure mode, the communication apparatuses (for example, the information processing apparatus 200 and the MFP 300) performing communication with one another are connected to the external access point (in this example, the AP 700) controlling the network, and communication between the apparatuses is performed via the AP. In other words, communication between the apparatuses is implemented via the network formed by the AP. Also, the MFP 300 operating in the wireless infrastructure mode operates as a station in the connection and communication with the access point 700.

In the wireless infrastructure mode, each device transmits a Probe Request and searches for an access point. When each device receives a Probe Response from an access point, the Service Set Identifier (SSID) included in the Probe Response is displayed. The information processing apparatus 200 and the MFP 300 each discover the access point 700 and transmit a connection request to the access point 700. Connecting to the access point 700 enables communication between the communication apparatuses in the wireless infrastructure mode via the access point 700.

Note that the plurality of communication apparatuses may be connected to different APs. In this case, the communication apparatuses can communicate by data being transferred between APs. The commands and parameters exchanged during communication between the communication apparatuses are only required to be compliant with Wi-Fi standards.

The access point 700 determines the frequency band and the frequency channel. For example, the access point 700 can select whether to use a 5 GHz frequency band or a 2.4 GHz frequency band and which frequency channel to use in the frequency band.

When the information processing apparatus 200 and the MFP 300 connect to the wireless LAN formed by the access point 700, authentication is performed by the access point 700. The information processing apparatus 200 and the MFP 300 connect to the wireless LAN formed by the access point 700 in accordance with the authentication method of the wireless LAN formed by the access point 700 using a wireless LAN authentication method such as the PSK method, the SAE method, the EAP method, or the like.

Note that the state of the MFP 300 operating in the wireless infrastructure mode connected to the access point 700 compatible with IEEE 802.1X authentication is illustrated in FIG. 10A. In this state, communication may be implemented between the MFP 300 and the information processing apparatus 200 on the basis of authentication performed by cooperation between the authentication server 800 and the access point 700.

Also, the state of the MFP 300 operating in the wireless infrastructure mode connected to the access point 700 not compatible with IEEE 802.1X authentication is illustrated in FIG. 10B. In this state, communication may be implemented between the MFP 300 and the information processing apparatus 200 without authentication performed by cooperation between the authentication server 800 and the access point 700.

Wired Communication Mode

Wired communication mode enables communication between a communication apparatus (for example, the MFP 300) and another communication apparatus via a wired interface such as a wired LAN. For example, when communication with the MFP 300 is executed in the wired communication mode, communication in the wireless infrastructure mode is restricted. In the wired communication mode, for example, data (packet) communication in a wired LAN (Ethernet) system compliant with the IEEE 802.3 series can be performed. When the MFP 300 operates in a state with the IEEE 802.1X/EAP setting enabled, the MFP 300 executes authentication according to IEEE 802.1X when connecting to the wired LAN formed by the access point 700.

Wireless Simultaneous Operation

When two modes of communication are both communication in which the authentication method does not use the authentication server 800, the MFP 300 enables communication via both modes to be executed simultaneously (in parallel). In other words, both connections for executing communication via the modes are simultaneously maintained. Specifically, for example, communication via the wireless infrastructure mode and communication via the P2P mode are both able to be executed simultaneously. Thus, the MFP 300 simultaneously maintains both a connection for communicating via the wireless infrastructure mode and a connection for communicating via the P2P mode. Such an operation may be referred to as wireless simultaneous operation. Note that to paraphrase, wireless simultaneous operation is, for example, an operation in which the MFP 300 simultaneously operates as a station for Wi-Fi communication via the wireless infrastructure mode and a master for Wi-Fi communication via P2P mode. On the other hand, when the MFP 300 performs communication via an authentication method using the authentication server 800, an infrastructure mode connection and a P2P connection are not both simultaneously maintained. At any one time, only a connection for Wi-Fi communication via one of the modes is maintained. When changing the communication mode, the maintained connection is disconnected and a connection via a new communication mode is established.

Screen Flow

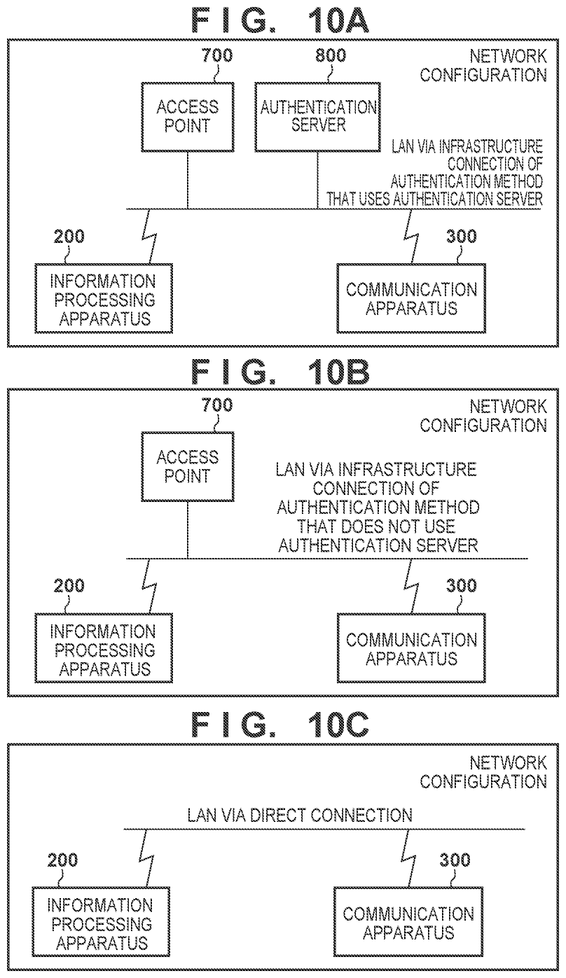

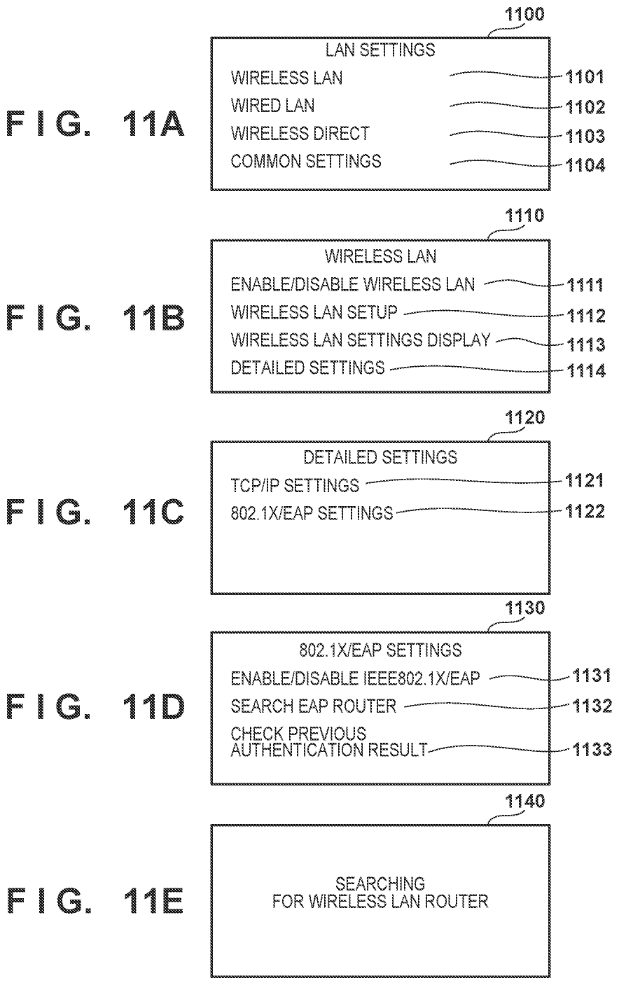

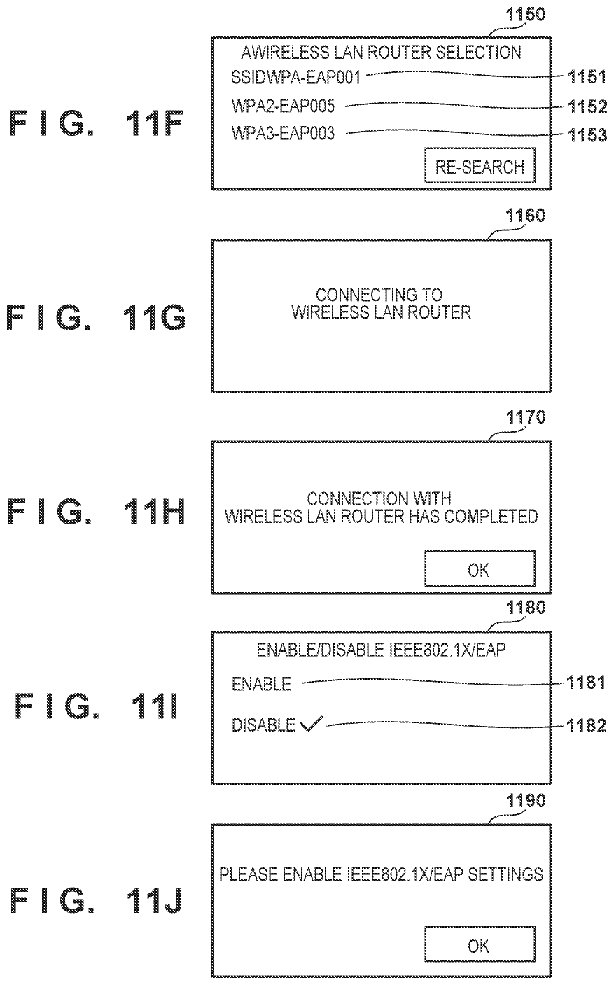

FIGS. 11A to 11J are screen flow diagrams of the operation display unit 302 of the MFP 300 of when the LAN settings are selected from the settings menu of the screen 408 of FIG. 4B.

A screen 1100 illustrated in FIG. 11A is a screen displayed when the LAN settings are selected on the screen 408 of FIG. 4B and is where LAN settings change can be executed. On the screen 1100, wireless LAN 1101, wired LAN 1102, wireless direct 1103, and common settings 1104 are displayed. To connect an access point compatible with the Personal method and the MFP 300, the user selects the wireless LAN 1101.

A screen 1110 illustrated in FIG. 11B is a screen displayed when the wireless LAN 1101 settings are selected on the screen 1100 of FIG. 11A and is where wireless LAN setting change can be executed. On the screen 1110, enable/disable wireless LAN 1111, wireless LAN setup 1112, wireless LAN settings display 1113, and detailed settings 1114 are displayed. The enable/disable wireless LAN 1111 is a region for setting whether to enable or disable a state in which the MFP 300 can communicate using wireless LAN. When a user operation is received on the display screen displayed after selecting this region, the state in which the MFP 300 can communicate using wireless LAN is disabled or enabled. Note that in the state in which the state has been disabled, the MFP 300 does not execute communication or connections using wireless LAN.

A screen 1120 illustrated in FIG. 11C is a screen displayed when the detailed settings 1114 are selected on the screen 1110 of FIG. 11B and is where detailed LAN settings change can be executed. On the screen 1120, TCP/IP settings 1121 and 802.1X/EAP settings 1122 are displayed.

A screen 1130 illustrated in FIG. 11D is a screen displayed when the 802.1X/EAP settings 1122 are selected on the screen 1120 of FIG. 11C and is where IEEE 802.1X/EAP setting change can be executed. On the screen 1130, enable/disable IEEE 802.1X/EAP 1131, EAP router search 1132, and check previous authentication result 1133 are displayed. Note that in this example, the EAP router that is the search target is a wireless LAN router with a wireless LAN access point function compatible with EAP. “EAP router” is an example for display, and the EAP router that is the search target may be a wireless access point that functions as an authenticator according to IEEE 802.1X.

A screen 1140 illustrated in FIG. 11E is a screen displayed while the wireless access point search of the authentication method using the authentication server 800 is being executed. When the IEEE 802.1X/EAP setting is enabled, the access point search may be executed in response to the EAP router search 1132 on the screen 1130 illustrated in FIG. 11D being selected. The screen 1140 is displayed while the searching continues.

Note that the screen 1140 illustrated in FIG. 11E is also displayed while a wireless access point search of an authentication method that does not use the authentication server 800 is being executed after the wireless LAN setup 1112 being selected on the screen 1110 illustrated in FIG. 11B.

A screen 1150 illustrated in FIG. 11F is an example of a screen displaying a list of identifier names (SSID) of wireless access points as the result of the search of an EAP wireless LAN router, or in other words an access point search (AP search). On the screen 1150 in this example, a SSIDWPA-EAP001 display 1151, a WPA2-EAP005 display 1152, and a WPA3-EAP003 display 1153 are displayed. These are compatible with the WPA-EAP method, the WPA2-EAP method, and the WPA3-EAP method, respectively.

Note that in another example of the display, known methods such as the WPA-PSK method, the WPA2-PSK method, the WPA3-SAE method, and the like may be displayed or an accompanying OPEN method may be displayed.

When the EAP router search 1132 is executed, on the screen 1150 illustrated in FIG. 11F, only SSIDs of authentication methods with an EAP access point are displayed. When the wireless LAN setup 1112 is executed, only SSIDs of authentication methods without an EAP access point are displayed.

A screen 1160 illustrated in FIG. 11G is a screen displayed while processing to connect the MFP 300 to the selected access point is executed after one of the SSIDs (1151 to 1153) of the access points on the screen 1150 illustrated in FIG. 11F is selected. In other embodiments, another display indicating that connection processing is in progress may be displayed.

A screen 1170 illustrated in FIG. 11H is a screen displayed after the screen 1160 illustrated in FIG. 11G is displayed when an attempt to connect to the access point is completed and connection is successful or when the connection moves on to a predetermined step.

A screen 1180 illustrated in FIG. 11I is a screen displayed when the enable/disable IEEE 802.1X/EAP 1131 is selected on the screen 1130 of FIG. 11D and is where the enable/disable IEEE 802.1X/EAP setting change can be executed. On the screen 1180, enable 1181 and disable 1182 are displayed. With the MFP 300, the IEEE 802.1X/EAP authentication method enabled state is a state in which authentication using the IEEE 802.1X/EAP authentication method and authentication using the Personal method are enabled. In other words, this is a state in which a connection to an access point compatible with the IEEE 802.1X/EAP authentication method can be made and a connection to an access point compatible with the Personal method can be made. Also, with the MFP 300, the IEEE 802.1X/EAP disabled state is a state in which authentication using the IEEE 802.1X/EAP authentication method is disabled and authentication using the Personal method is enabled. In other words, this is a state in which a connection to an access point compatible with the IEEE 802.1X/EAP authentication method cannot be made and a connection to an access point compatible with the Personal method can be made.

A screen 1190 illustrated in FIG. 11J is a screen displayed when the EAP router search 1132 is selected when the IEEE 802.1X/EAP setting on the screen 1130 illustrated in FIG. 11D is disabled. In other words, in the present embodiment, when the IEEE 802.1X/EAP setting is disabled, a router search is not executed even when the EAP router search 1132 is selected.

Note that control to not execute a connection with an access point using IEEE 802.1X/EAP authentication executed when the IEEE 802.1X/EAP setting is disabled is not limited to the control described above. For example, the MFP 300 may execute a router search but may not display access points from the list of access points discovered via the router search that have IEEE 802.1X/EAP authentication enabled. Alternatively, the MFP 300 may display access points that have IEEE 802.1X/EAP authentication enabled but may not execute processing to connect to an access point that has IEEE 802.1X/EAP authentication enabled even if it is selected by the user.

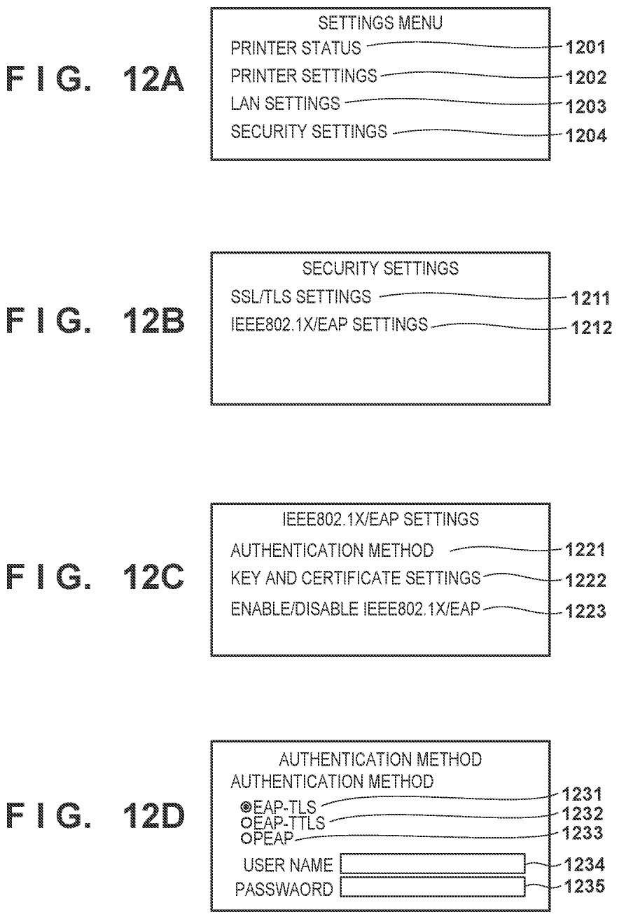

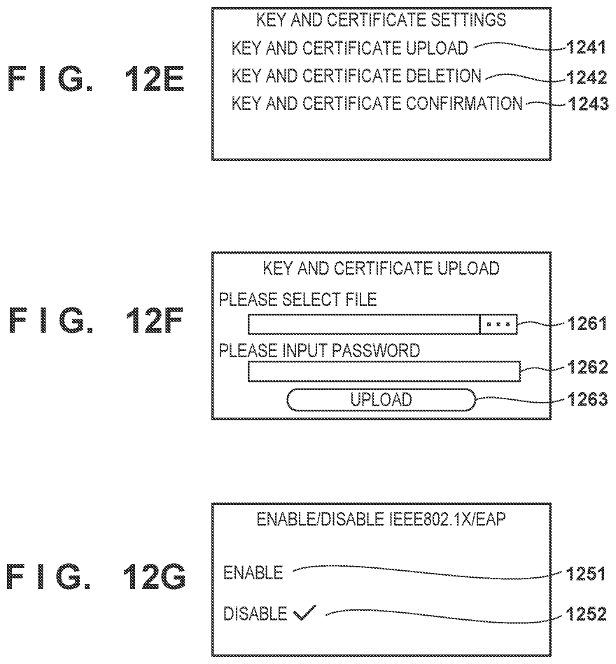

FIG. 12A is a diagram illustrating an example of a settings screen for the MFP 300 displayed on the information processing apparatus 200. This screen is displayed by a WEB browser or application operating on the information processing apparatus 200 communicating with the HTTP server operating on the MFP 300. Specifically, for example, by the IP address of the MFP 300 being input into the WEB browser operating on the information processing apparatus 200, the information processing apparatus 200 accesses the MFP 300. Then, in response to this access, the MFP 300 provides screen information for displaying the screens illustrated in FIGS. 12A to 12G to the information processing apparatus 200. Next, the information processing apparatus 200 displays the screens illustrated in FIGS. 12A to 12G on the basis of the screen information provided by the MFP 300. In other words, the screens illustrated in FIGS. 12A to 12G are examples of remote user interfaces (remote UI) relating to settings that are displayed on the information processing apparatus 200 on the basis of the screen information provided by the MFP 300. The screen may be displayed on the basis of a wait response to an HTTP request for USB communication using the USB communication control unit 320 of the MFP 300. On the screen, printer status 1201, printer settings 1202, LAN settings 1203, and security settings 1204 are displayed.

FIG. 12B is displayed when the security settings 1204 in FIG. 12A is selected. On the screen, SSL/TLS settings 1211 and IEEE 802.1X/EAP settings 1212 are displayed.

FIG. 12C is displayed when the IEEE 802.1X/EAP settings 1212 in FIG. 12B is selected. On the screen, authentication method 1221, key and certificate settings 1222, and enable/disable IEEE 802.1X/EAP 1223 are displayed.

FIG. 12D is displayed when the authentication method 1221 in FIG. 12C is selected. On the screen, under the authentication method, EAP-TLS display 1231, EAP-TTLS display 1232, and PEAP display 1233 are displayed, and a username (login name) input field 1234 and a password input field 1235 are displayed. In this example, the authentication method used when performing IEEE 802.1X/EAP authentication is set for the MFP 300 by selecting one method from 1231 to 1233. Also, the username and password used when performing IEEE 802.1X/EAP authentication is set for the MFP 300 by entering the username and the password in 1234 and 1235.

When a certificate used in IEEE 802.1X/EAP authentication is registered in the MFP 300, first, the key and certificate settings 1222 on the screen illustrated in FIG. 12C is selected. Then, in the case of EAP-TLS, for example, key and certificate upload 1241 on a screen illustrated in FIG. 12E is selected to display a screen illustrated in FIG. 12F. On this screen, by selecting upload 1263 after selecting a file for the certificate in a field 1261 and entering the password in a field 1262 as the key, upload (transmission) of the key and the certificate to the MFP 300 is completed. The key and certificate specified by the upload is set in the MFP 300, and the input username and password are also set together in the MFP 300. The MFP 300 obtains the location and the file name of the certificate file, the key information, and the username and password from the information processing apparatus 200 and uses the obtained information to set the settings relating to IEEE 802.1X/EAP authentication.

Note that on the screen illustrated in FIG. 12E, with a delete key and certificate 1242, the certificate stored in the MFP 300 can be deleted, and with a confirm key and certificate 1243, a list of the certificates stored in the MFP 300 can be displayed.

FIG. 12G is displayed when the enable/disable IEEE 802.1X/EAP 1223 illustrated in FIG. 12C is selected. On this screen, the IEEE 802.1X/EAP settings of the MFP 300 can be enabled or disabled. On the screen, enable 1251 and disable 1252 are displayed in FIG. 12G. Note that enabling IEEE 802.1X/EAP means putting the MFP 300 in an IEEE 802.1X/EAP-enabled state. Also, disabling IEEE 802.1X/EAP means putting the MFP 300 in an IEEE 802.1X/EAP-disabled state.

When a user operation is performed on the screens illustrated in FIGS. 12A to 12G, the MFP 300 receives information relating to authentication used in the IEEE 802.1X/EAP authentication method and the settings relating to the EAP are set for the MFP 300 on the basis of the information. In other words, information relating to authentication includes information corresponding to the methods of IEEE 802.1X authentication including the authentication method used in IEEE 802.1X/EAP authentication, the username and password used in authentication, and the key and certificate used in authentication.

In this manner, the authentication information used in IEEE 802.1X/EAP may be set in the MFP 300. By using the authentication information and authenticating the MFP 300 with the authentication server 800, the MFP 300 can connect to the network using the authentication server 800 formed by the access point 700. Thus, when the MFP 300 can simultaneously enable a plurality of modes (in this example, an infrastructure mode connection and a P2P connection), the MFP 300 can connect to the network using the authentication server 800 via an infrastructure mode connection and can connect to another communication apparatus via P2P. In this case, a request to change the MFP 300 settings or a request to print can be received from another communication apparatus, for example the information processing apparatus 200, that is not authenticated by the authentication server 800.

Processing Executed by MFP 300

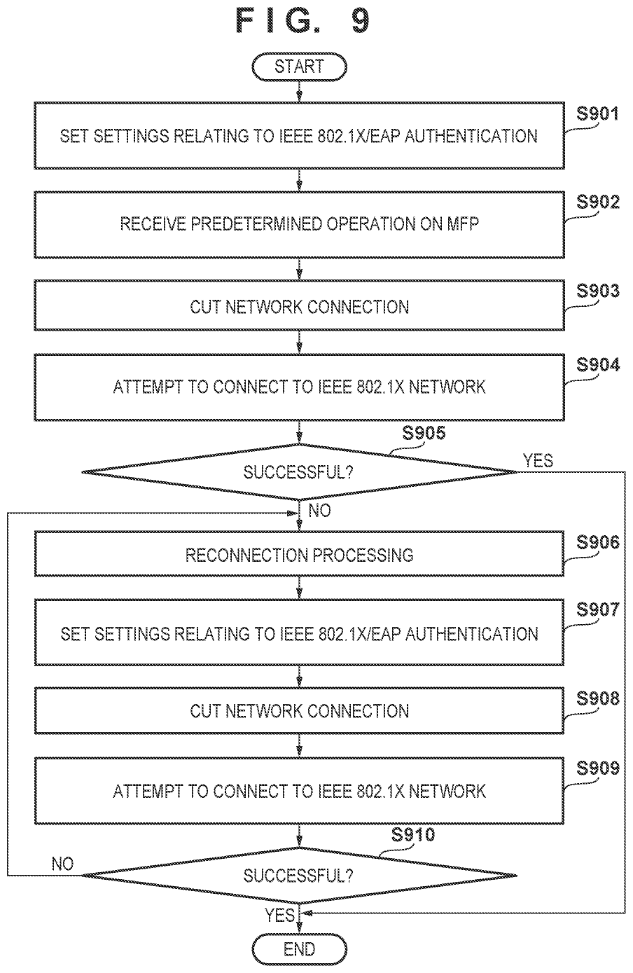

FIG. 9 is a flowchart illustrating the processing executed by the MFP 300. Note that the flowchart is implemented by the CPU 311 loading a program stored in the program memory 313 on the data memory 314 and executing the program. Also, the present flowchart is started when the MFP 300 and the information processing apparatus 200 are in a connected state connected via a network. Note that at this time, the MFP 300 may connect to the information processing apparatus 200 via an infrastructure mode connection or may connect to the information processing apparatus 200 via a direct connection. Also at this time, the MFP 300 may be in wireless infrastructure mode, may be in P2P mode, or may be in a simultaneous operation state.

In step S901, the CPU 311 receives authentication information from the information processing apparatus 200 and uses this information to set the settings relating to IEEE 802.1X/EAP authentication. Specifically, as described above, when the CPU 311 receives access from the information processing apparatus 200, the CPU 311 provides information for displaying the screens illustrated in FIGS. 12A to 12G to the information processing apparatus 200 connected to the MFP 300. The information processing apparatus 200 displays the screens illustrated in FIGS. 12A to 12G on the basis of the received information and receives input for the settings relating to IEEE 802.1X/EAP authentication from the user. Then, the information processing apparatus 200 transmits, to the MFP 300, authentication information for setting the settings corresponding to the received input for the MFP 300. In this manner, the received authentication information is received in step S901. Note that when the authentication information is received and the MFP 300 is already connected to an access point compatible with IEEE 802.1X/EAP authentication, since the previous settings are deleted by the settings based on the authentication information, the MFP 300 may terminate (or disconnect) the connection to the access point.

In step S902, the CPU 311 receives a predetermined user operation on the MFP 300. The predetermined user operation is, for example, an operation for establishing a connection between the MFP 300 and an access point compatible with IEEE 802.1X/EAP authentication.

On the basis of the predetermined user operation being received in step S902, processing to establish a connection between the MFP 300 and the access point compatible with IEEE 802.1X/EAP authentication is executed. Note that at this time, the MFP 300 has the IEEE 802.1X/EAP settings set to enabled by the settings set in step S901 or by settings set before the flowchart of FIG. 9 is started. Also, the processing to establish a connection between the MFP 300 and an access point compatible with IEEE 802.1X/EAP authentication corresponds to steps S903 and S904 of the present embodiment.

In step S903, the CPU 311 terminates the connection between the MFP 300 and the network the MFP 300 is currently connected to. Specifically, for example, when the MFP 300 is connected to a network in the wireless infrastructure mode, the connection between the MFP 300 and an external access point is terminated. Note that when the connection between the external access point and the MFP 300 is already terminated, the present processing is omitted. Also, for example, when the MFP 300 is in P2P mode, the connection between the MFP 300 and the other apparatus the MFP 300 is connected to via P2P is terminated. Furthermore, for example, when the MFP 300 is in the simultaneous operation state, both the connection between the MFP 300 and the external access point and the connection between the MFP 300 and the other apparatus the MFP 300 is connected to via P2P are terminated. Note that at this time, the CPU 311 stores the information for returning to the network connection state of before the disconnection processing.

In step S904, the CPU 311, on the basis of the contents set in step S901, attempts to establish a connection between the MFP 300 and a network established by the access point 700 with IEEE 802.1X/EAP enabled.

In step S905, the CPU 311 determines whether or not the connection attempted in step S904 is successful. When the CPU 311 determines that the connection is successful, the screen 1170 illustrated in FIG. 11H is displayed, and the processing of the present flowchart ends. When a failure is determined, the processing proceeds to step S906. Note that failure in the attempt of step S904 to establish a connection may mean, for example, that the contents set in step S901 are incorrect. In other words, in the information processing apparatus 200, the contents entered by the user via the screens illustrated in FIGS. 12A to 12G may be incorrect.

In step S906, the CPU 311 executes the processing to return to the network connection state of before the disconnection processing of step S903 on the basis of the information stored in step S903. Specifically, for example, when the MFP 300 communicates via the wireless infrastructure mode before the disconnection processing, a connection between the MFP 300 and an external access point is established. Also, for example, when the MFP 300 communicates via P2P mode before the disconnection processing, a direct connection-enabled state is transitioned to. A direct connection-enabled state, for example, is a state of operating as a software AP, a state of operating as a group owner, and a state in which group owner negotiation can be executed. When a connection request is received from another apparatus with the MFP 300 operating in this state, the MFP 300 establishes a direct connection with the other apparatus. Also, for example, when the MFP 300 is in a simultaneous operation state, the CPU 311 establishes a connection between the external access point and the MFP 300 and transitions to a state in which direct connection can be performed.

Note that, for example, when the MFP 300 has been connected to an access point compatible with IEEE 802.1X/EAP in the wireless infrastructure mode before the disconnection processing, the settings relating to IEEE 802.1X/EAP authentication are updated. Thus, the MFP 300 cannot return to the network connection state of before the disconnection processing. Also, for example, when the access point to which the MFP 300 is connected is disabled due to power being OFF or the like before the disconnection processing, the MFP 300 cannot return to the network connection state of before the disconnection processing. When the MFP 300 cannot return to the network connection state of before the disconnection processing, for example, the MFP 300 may transition to a state in which direct connection can be performed. Also, for example, the MFP 300 may search for an access point near the MFP 300, display a list of one or more access points discovered, and establish a connection with an access point selected from the list.

Note that the processing of step S906 is not limited to the contents described above, and the network connection state of before the disconnection processing in step S903 does not need to be returned to. In step S906, it is sufficient that the MFP 300 can connect to the information processing apparatus 200 via any one of the methods. Specifically, for example, the CPU 311 may search for an access point near the MFP 300 that can connect via the Personal method and display a list of the discovered access points. Also, the CPU 311 may establish a connection between the selected access point and the MFP 300. When the information processing apparatus 200 is connected to the selected access point, the MFP 300 can connect to the information processing apparatus 200 via the processing described above.

In step S907, the CPU 311 receives authentication information from the information processing apparatus 200 and uses this information to set the settings relating to IEEE 802.1X/EAP authentication. This processing is similar to the processing of step S901.

Note that at this time, even though a predetermined user operation has been received in step S902, a connection between the MFP 300 and an access point compatible with IEEE 802.1X/EAP authentication has failed to be established. In the present embodiment, when the connection establishment fails, the predetermined user operation is not received after the settings relating to IEEE 802.1X/EAP authentication are re-set. In this case, without receiving the predetermined user operation, processing is automatically executed to establish a connection between the MFP 300 and an access point compatible with IEEE 802.1X/EAP authentication. In other words, in step S907, on the basis of the settings relating to IEEE 802.1X/EAP authentication being set, processing is automatically executed to establish a connection between the MFP 300 and an access point compatible with IEEE 802.1X/EAP authentication. The processing automatically executed to establish a connection between the MFP 300 and an access point compatible with IEEE 802.1X/EAP authentication corresponds to steps S908 and S909.

In step S908, the CPU 311 terminates the connection between the MFP 300 and the network the MFP 300 is currently connected to. This processing is similar to the processing of step S903.

In step S909, the CPU 311, on the basis of the contents set in step S907, attempts to establish a connection between the MFP 300 and a network established by the access point 700 with IEEE 802.1X/EAP enabled.

In step S910, the CPU 311 determines whether or not the connection attempted in step S909 is successful. When the CPU 311 determines that the connection is successful, the processing of the present flowchart ends. When a failure is determined, the processing returns to step S906.

In the example described above, when authentication via IEEE 802.1X/EAP fails, a connection is re-established with the network or another apparatus. Then, with the re-established connection, after the user sets the IEEE 802.1X/EAP settings, another attempt is made to access an access point using a communication method that requires IEEE 802.1X/EAP authentication and to connect and communicate.

When the MFP 300 connects to the network using the authentication server 800 via an infrastructure mode connection, irrespective of the communication mode switching order, MFP 300 settings change and printing execution by an apparatus not authenticated by the authentication server 800 can be inhibited. However, in the present embodiment, since the communication mode dynamically switches depending on the MFP 300 IEEE 802.1X/EAP settings and the authentication method of the wireless infrastructure mode, the time required to set the communication mode can be reduced.

Note that in the present embodiment, the enabled (ON state) and disabled (OFF state) state of each of the communication modes are managed. For example, with the MFP 300, by controlling the wireless communication unit 307 and the wired LAN communication unit 321, switching of the enabled communication mode and communication can be controlled.

Explained in more general terms, for apparatuses other than MFPS, such as various sensor apparatuses and input-output apparatuses, which have poor or no UIs, the user often uses a remote user interface (remote UI) to set communicate settings and the like. The invention according to the present embodiment can be applied to such communication apparatuses which have settings set via a remote UI. In other words, when authentication is required for one communication method provided by a communication function included in such an apparatus and the settings therefor are not set or authentication has failed, a remote UI cannot be provided via the communication method. Thus, by providing a remote UI via another communication method that does not require authentication, the user can set the settings via a remote UI.

The names of the components and functional units described in the embodiment described above are referred to as such in the present specification on the basis of the main function. However, these may be referred to on the basis of their subsidiary function. Thus, the present invention is not strictly limited to these expressions (and these expressions can be substituted with a similar expression). Similarly, the term “unit” may be substituted with “part”, “member”, “structure”, “assembly”, “circuit”, and the like or may be omitted.

Other Embodiments

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-025604, filed Feb. 22, 2022 which is hereby incorporated by reference herein in its entirety.

What is claimed is:

1. A communication apparatus comprising:
at least one processor; and
at least one memory including at least one program,
wherein the at least one program causes the at least one processor to
receive first information relating to IEEE 802.1X authentication from an information processing apparatus via a first wireless connection between the communication apparatus and another apparatus,
terminate the first wireless connection,
execute the IEEE 802.1X authentication based on the first information received in a state in which the first wireless connection is not established, and
execute processing to re-establish the first wireless connection on the basis of the IEEE 802.1X authentication failing.

2. The communication apparatus according to claim 1,
wherein, after the processing to re-establish the first wireless connection is executed, second information relating to the IEEE 802.1X authentication is received from the information processing apparatus via the first wireless connection, and
wherein the IEEE 802.1X authentication based on the second information received is executed in a state in which the first wireless connection is not established.

3. The communication apparatus according to claim 2,
wherein the IEEE 802.1X authentication based on the first information received is executed on the basis of a predetermined user operation being executed on the communication apparatus after the first information has been received, or
automatically executed without execution of the predetermined user operation after the second information has been received.

4. The communication apparatus according to claim 1,
wherein the at least one program further causes the at least one processor to transmit information for displaying a screen for input relating to the IEEE 802.1X authentication to the information processing apparatus via the first wireless connection, and
wherein the first information is information based on input to the screen.

5. The communication apparatus according to claim 1,
wherein the first wireless connection is a direct connection between the information processing apparatus and the communication apparatus bypassing an external access point.

6. The communication apparatus according to claim 5,
wherein the processing to re-establish the first wireless connection is processing to transition to a state in which the direct connection can be performed.

7. The communication apparatus according to claim 1,
wherein the first wireless connection is a connection between an external access point and the communication apparatus.

8. The communication apparatus according to claim 7,
wherein the processing to re-establish the first wireless connection is processing to establish a connection between the external access point and the communication apparatus.

9. The communication apparatus according to claim 8,
wherein when the first wireless connection is a connection between the communication apparatus and the external access point compatible with an authentication different from the IEEE 802.1X authentication, processing is executed to re-establish the first wireless connection, and
wherein when the first wireless connection is a connection between the communication apparatus and the external access point compatible with the IEEE 802.1X authentication, processing is not executed to re-establish the first wireless connection.

10. The communication apparatus according to claim 8,
wherein when the first wireless connection is a connection between the communication apparatus and the external access point compatible with the IEEE 802.1X authentication, processing is executed to establish a direct connection between the information processing apparatus and the communication apparatus bypassing an external access point.

11. The communication apparatus according to claim 8,
wherein when the first wireless connection is a connection between the communication apparatus and the external access point compatible with the IEEE 802.1X authentication, processing is executed to establish a connection between the communication apparatus and the external access point compatible with an authentication different from the IEEE 802.1X authentication.

12. The communication apparatus according to claim 11,
wherein processing to establish a connection between the communication apparatus and the external access point compatible with an authentication different from the IEEE 802.1X authentication includes processing to display a list of one or a plurality of the external access points compatible with an authentication different from the IEEE 802.1X authentication and establish a connection between the communication apparatus and the external access point selected from the list.

13. The communication apparatus according to claim 1,
wherein the at least one program further causes the at least one processor to establish a second connection between the communication apparatus and an external access point compatible with the IEEE 802.1X authentication after the first information is received, and
wherein the IEEE 802.1X authentication based on the first information received is executed in a state in which the second connection is established.

14. The communication apparatus according to claim 1,
wherein when the IEEE 802.1X authentication is successful, processing to re-establish the first wireless connection is not executed.

15. The communication apparatus according to claim 1,
wherein the at least one program further causes the at least one processor to switch between a first state in which the communication apparatus can execute the IEEE 802.1X authentication and authentication different from the IEEE 802.1X authentication and a second state in which the communication apparatus cannot execute the IEEE 802.1X authentication and can execute authentication different from the IEEE 802.1X authentication.

16. The communication apparatus according to claim 1,
wherein the IEEE 802.1X authentication is an authentication method using an authentication server that operates via an Extensible Authentication Protocol (EAP).

17. The communication apparatus according to claim 1,
wherein authentication different from the IEEE 802.1X authentication can be executed, and
wherein the authentication different from the IEEE 802.1X authentication is a method using a Pre Shared Key (PSK) or a method using a Simultaneous Authentication of Equals (SAE).

18. The communication apparatus according to claim 1,
wherein the first information includes at least one from among an authentication method used in the IEEE 802.1X authentication, a username used in the IEEE 802.1X authentication, a password used in the IEEE 802.1X authentication, a key used in the IEEE 802.1X authentication, and a certificate used in the IEEE 802.1X authentication.

19. The communication apparatus according to claim 1, further comprising:
a printer that executes printing.

20. A method of controlling a communication apparatus comprising:
receiving first information relating to IEEE 802.1X authentication from an information processing apparatus via a first wireless connection between the communication apparatus and another apparatus;
terminating the first wireless connection;
executing the IEEE 802.1X authentication based on the first information received in a state in which the first wireless connection is not established; and
executing processing to re-establish the first wireless connection on the basis of the IEEE 802.1X authentication failing.
